(19) United States
(12) Patent Application Publication
(10) Pub. No.: US 2005/0178313 A1
(43) Pub. Date: Aug. 18, 2005

(54) Method and device for visual vehicle location

(76) Inventor: DeArmond Leigh, Reno, NV (US)

Correspondence Address: DEARMOND LEIGH, 10210 WHITE OWL DR., RENO, NV, 89506, US

(21) Appl. No.: 10/959,719

(22) Filed: Oct. 6, 2004

Related U.S. Application Data
(60) Provisional application No. 60/481,459, filed on Feb. 17, 2004.

(51) Int. Cl. G09F 17/00

(52) U.S. Cl. 116/173

(57) ABSTRACT

The method and device for visual vehicle location is an apparatus for vehicles that are in off-highway locations that require an appropriate flag or banner to be displayed in a manner that is in compliance with certain state and various jurisdictional laws. Said apparatus is constructed of materials to provide strength, flexibility, and durability.

Claiming the benefit of a prior filed copending nonprovisional application; reference to such prior application, identifed by the application Ser. No. 60/481,459. The filing date was Oct. 2, 2003 subsequentially amended to Oct. 9, 2003 by NOTICE OF INCOMPLETE PROVISIONAL APPLICATION Formalities Letter, confirmation no. 1459, for having the application deposited without drawings. The relationship of this application is that it is the same invention by the same inventor making application for said invention as a nonprovisional utility patent.

### BACKGROUND OF INVENTION

When operating vehicles in such off-highway locations where there are mountains, rolling or small undulating hills or terrain, the actual body of the vehicle can be obscured from view from the operator of another vehicle in the same general geographical location if said mountains, rolling or undulating terrain is located between the different vehicles and their respective operators. There are certain geographical locations where various laws have been enacted that require said situations, as mentioned, to be addressed.

Laws require a certain shape and colored flag or pennant to be displayed at a certain height above the ground when mounted to vehicle when operating in these restricted geographical locations. With the use of such an apparatus the location of another vehicle can be ascertained by seeing said flag or pennant over the crest of mountains, rolling or undulating terrain or above the tops of obstacles, man made or natural, before the actual vehicle body is sighted. This event allows for the forewarning of the approach of another vehicle allowing more time for evasive maneuvering by operators of the vehicles to avoid collision or interference between vehicles.

Laws do not require, but safety dictates that an addition to the apparatus be made to support and display a light source and assembly at the top of said invention at or near the flag or pennant. This would greatly enhance visibility of the obstructed vehicle at night or under poor lighting conditions.

Said light source and assembly would also allow for visual detection of vehicle at night in case the vehicle suffers a mechanical breakdown or malfunction.

### SUMMARY OF INVENTION

The dictates of law, the concern for safety, use in an outdoor environment, on fast moving vehicles in rough terrain, exposure to Weather from hot desert sun, to rain or snow; extreme vibration and hard physical mechanical abuse requires the method and device for visual vehicle location to be mechanically strong, flexible, and weather resistant and moisture proof. Said invention has capability to support the correct shaped flag or pennant at the correct height and house a lighting assembly and associated electrical circuitry in a protected manner to allow for long and reliable illumination of said lighting assembly.

Said invention provides for means for quick removal and connection to vehicle.

Height adjustment of required flag or pennant with light assembly is provided for use in geographical in geographical locations that do not require fulfillment of certain requirements of law but need to display flag or pennant with light assembly for safer operation of vehicle.

Main body of said invention is constructed from tubing, which can be made from one of various materials. The preferred mode is tubing made from metal of sufficient tensile strength, flexibility, electrical conductivity and weather resistance.

Main body of said invention is constructed with fittings to allow for lengthening or shorting of the apparatus length, and for mounting and dismounting from the vehicle. The preferred method uses bayonet connectors to join lengths of tube together and to join to mounting bracket on vehicle.

Said bayonet connectors are made of materials that provide mechanical strength and weather resistance. Construction and use of bayonet components will allow for quick and reliable joining and rejoining of attached tubing into a giving length, and the joining of attached components of said invention to a vehicle.

Said bayonet connectors will be housed within a housing that will provide added mechanical strength and integrity, to offer protection to such connectors, giving added strength to longitudinal axis of the tubing and bayonet connectors. The preferred method is CNC machine metal turned to form a one-piece housings that encloses the ends of the tubes where they are connected to the bayonet connectors and surrounding the said bayonet connectors in their entirety.

Said invention incorporates the use of a flag or pennant attached to the upper most end of the tube through the use of various available methods of attachment. Preferred method is a hollow sleeve incorporated in one end of said pennant or flag to allow the passage of the tube to securely pass through. The said sleeve will be constructed in such manner as to make for a tight fit around the diameter of the tube. A tight fitting sleeve allows friction to hold flag on pennant at the upper most end of said invention.

The light source assembly needs to be housed in a mechanically sturdy housing. Housing should accommodate the ability to turn light on and off, provide mechanical protection from environment concerns, such as weather, vibration and shock resistance. The housing should allow for permanent attachment of light source assembly to the top end of the upper most tube of said invention. Housing should accommodate access to the lighting element of the light source subassembly; contain dry cell batteries for energy back-up in case of failure in the operation of other electrical power source or lack there of from vehicle to which said invention is attached. The preferred method for this invention is to CNC machine housing from metal to provide mechanical strength, and weather resistance. The CNC machining of required components that when assembled together will provide a twist on and off type switch. The use of various internal snap rings and machined shoulder stops to provide movement stops for going from off to on and vice-versa. To allow the use of “O” rings to provide moisture proofing and add turning resistance to the on/off switch mechanism-preventing vibrations from causing the on/off mechanism to rotate without outside physical manipulation causing activation or deactivation of the light source.

Said invention needs to have a vehicle mounting subassembly that provides flexibility, mechanical strength, weather resistance, along with the ability to absorb shock and vibrations. There needs to be incorporated into the design the ability to connect and disconnect said invention quickly and easily from the vehicle and to allow for adjustability of the length of said invention to be carried out. The preferred method for this invention is to a coiled expansion spring made of a type of metal that incorporates weather resistance and mechanical strength to support said invention. The use of aforementioned bayonet connectors and associated housing shall be incorporated into the design to accommodate the quick and easy, yet mechanically strong, type of connection for said invention. The mounting subassembly shall incorporate the ability to be bolted to the vehicle.

### BRIEF DESCRIPTION OF THE DRAWINGS

These and other attributes of the invention will become more clear upon a thorough study of the following description of the best mode for carrying out the invention, particularly reviewed in conjunction with the drawings, wherein:

FIG. 1 is a cross-sectional plan view taken along the longitudinal axis of the fully assembled invention.

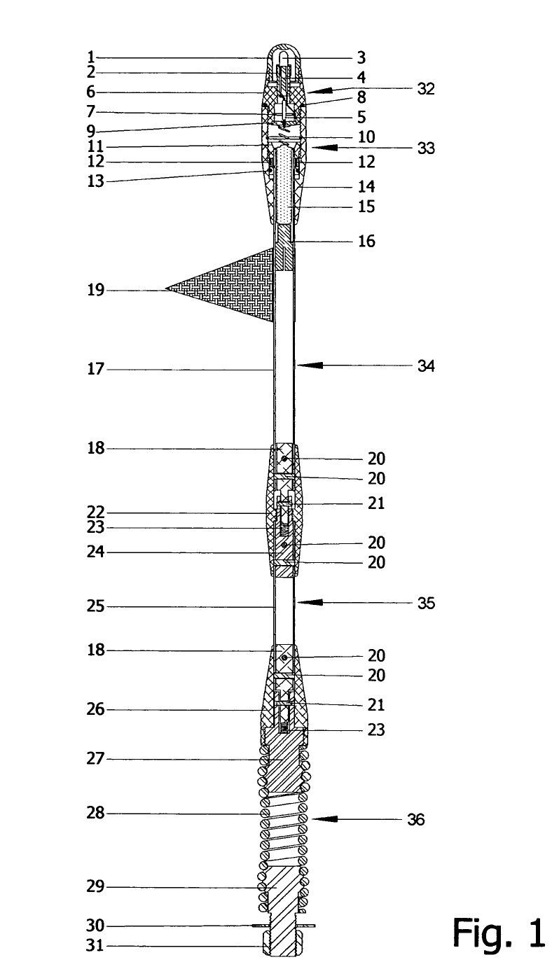

FIG. 2 is a cross-sectional plan view taken along the longitudinal axis of the light housing subassembly (32).

FIG. 3 is a cross-sectional plan view taken along the longitudinal axis of the on/off screw switch mechanism subassembly (33).

FIG. 4 is a cross-sectional plan view taken along the longitudinal axis of the upper tube subassembly (34).

FIG. 5 is a cross-sectional plan view taken along the longitudinal axis of the lower tube subassembly (35).

FIG. 6 is a cross-sectional plan view taken along the longitudinal axis of the spring mount subassembly (36).

### DETAILED DESCRIPTION

Referring now to the drawings, wherein like reference numerals designate identical or corresponding parts throughout the several views. A lamp (3), such as a light emitting diode, also referred to as an L.E.D., mounted in a conventional fashion within a commercially available L.E.D. lamp holder (4), which is mounted in a light housing subassembly (32), which attaches to the on/off screw switch mechanism subassembly (33), which makes or breaks the electrical contact with the battery (15). A flag (19) is attached firmly around the tube (17) just below the on/off screw switch mechanism subassembly (33). These aforementioned components and subassemblies are attached to a vehicle at the appropriate height with the use of upper tube subassembly (34) and lower tube subassembly (35) and mounting subassembly (36), which constitutes the subject matter of this invention.

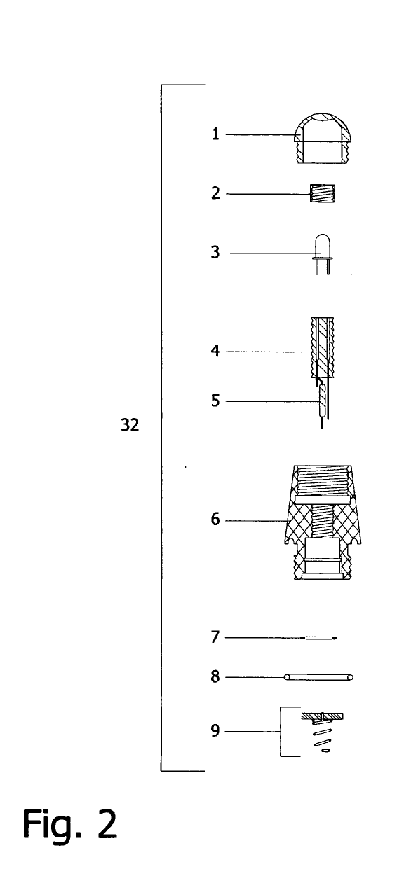

As illustrated in FIG. 2, L.E.D. (3) is inserted into the L.E.D. lamp holder (4) with the L.E.D. electrical negative lead inserted into the negative lead receptacle of the L.E.D. holder (4). One lead of resistor (5) is wrapped and soldered on the electrical negative lead extending from the opposite end of the L.E.D. holder (4) From which the L.E.D. (3) was inserted. L.E.D. holder cap nut (2) is placed over and screwed onto the L.E.D. holder (4) to secure the L.E.D (3) in place. Take assembled units (2, 3, 4, 5) and insert, resistor (6) end first, into the opening with the internal threads of the light holder housing (6) until seated against the lower edge of the L.E.D. holder cap nut (2). Screw lens cover (1) into the threads located at the top of light holder housing (6) until the lens cover's (1) shoulder rest on the top edge of the light holder housing (6). From the other end of the light holder housing (6) lay the other lead of the resistor (5) across the groove on the in side. Insert internal snap ring (7) into the same said groove as to press the resistor (6) lead into the groove which makes for negative electrical contact between the light holder housing (6) through the resistor (5) to the negative lead of the L.E.D. (3). Battery contact spring (9) is a commercially available unit consisting of a metal spring riveted with a feed-through rivet to a non-electrically conducting washer. Feed the other lead from the L.E.D. holder (4) through the center of the feed through rivet used on the battery contact spring (9) with the spring facing away from the light holder housing (6). Seat the washer of the battery contact spring (9) on the internal shoulder in the base of the light holder housing (6). Solder said lead to feed-through rivet. This is the positive electrical input from the battery. Insert “O” ring (8) into the groove turned into the face of the shoulder located on the out side of the light holder housing (6).

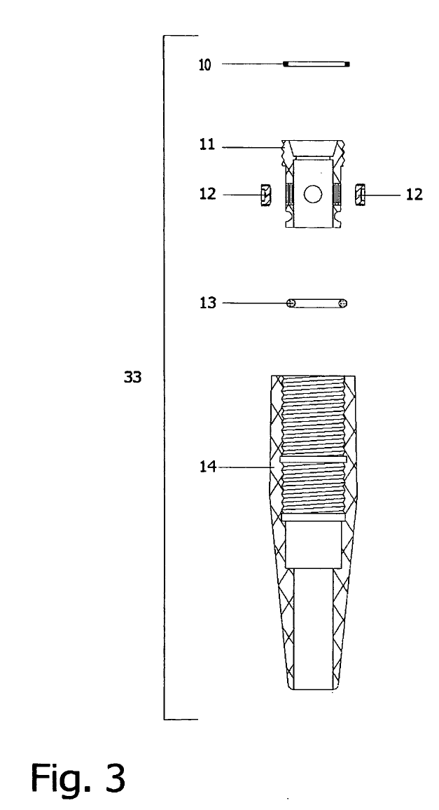

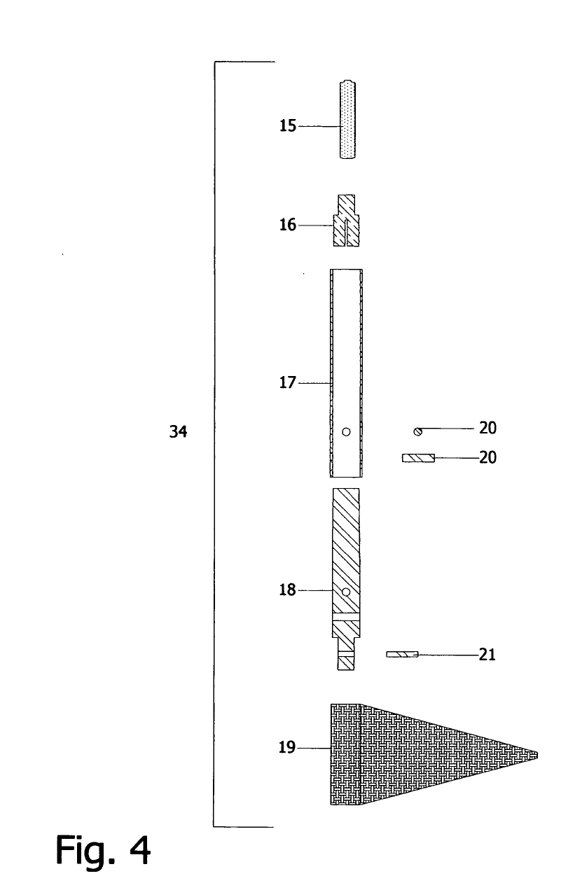

As illustrated in FIG. 3 and FIG. 4, upper tube (17) is secured to the male bayonet connector (18) by the use of two metal pins (20) that are inserted through two corresponding holes drilled in tube (17) and male bayonet connector (18). The pins (20) and holes are constructed so as to achieve a tight compression fit and the length of the pins (20) is not to exceed the outside diameter of the tube (17). Pin (21) is shorter than the inside diameter of tube (17) and is press fitted into the hole in male bayonet connector (18), this forms the lower end of the upper tube sub assembly (34). Plug (16) is press fitted into the end of tube (17) at a depth of approximately the length of the battery (15). This plug (16) provides the negative electrical contact for the battery (15) in the lighting of the L.E.D. (3). Housing (14) slides over the end of the tube (17). Rubber “O” ring (13) is inserted into the groove around the circumference located near the end of screw switch mechanism (11). The screw switch mechanism (11) is now set onto the end of tube (17) and held in place by inserting and tightening the set screws (12) into the holes that are drilled and tapped around the body of the screw switch mechanism (11), tightening the set screws (12) until they seat firmly into the sides of the tube (17). Rotate the housing (14), in a clockwise direction while keeping tube (17) from rotating, up and around the screw switch mechanism (11) until the housing (14) internal shoulder stops meet the lower edge of the screw switch mechanism (11), this is the position that will cause the positive end of the battery (15) to make electrical contact with the battery contact spring (9) completing the electrical circuit to turn on the L.E.D. Place internal snap ring (10) into groove on the inside of housing (14), this is the stop for the screw switch mechanism (11) when the housing (14) is rotated in the counter-clockwise direction. Place battery (15) into tube (17) with the negative end of the battery resting against the plug (16). Insert the lower end of the upper tube assembly (34) into the sleeve sewn into the end edge of the flag (19). Slide flag (19) up around tube (17) until just below the on/off screw switch mechanism subassembly (33).

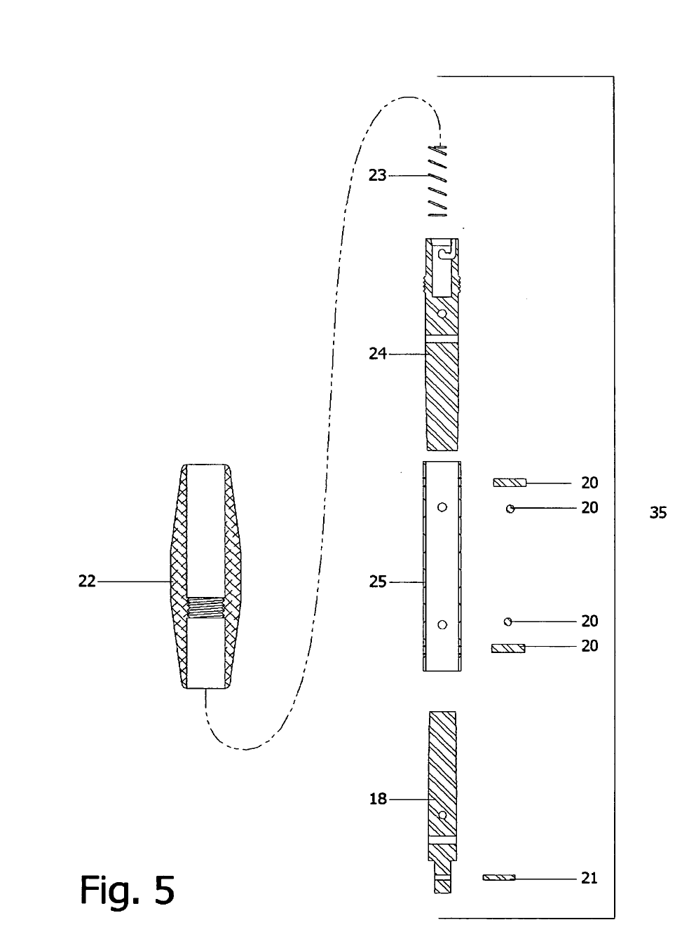

As illustrated in FIG. 5, upper tube (25) is secured to the male bayonet connector (18) by the use of two metal pins (20) that are inserted through two corresponding holes drilled in tube (17) and male bayonet connector (18). The pins (20) and holes are constructed so as to achieve a tight compression fit and the length of the pins (20) is not to exceed the outside diameter of the tube (25). Pin (21) is shorter than the inside diameter of tube (25) and is press fitted into the hole in male bayonet connector (18), this forms the lower end of the lower tube subassembly (35). Upper tube (17) is secured to the female bayonet connector (24) by the use of two metal pins (20) that are inserted through two corresponding holes drilled in tube (24) and female bayonet connector (24). The pins (20) and holes are constructed so as to achieve a tight compression fit and the length of the pins (20) is not to exceed the outside diameter of the tube (17). Compression spring (23) is formed with the bottom coil made slightly larger than the inside diameter of the machined hole in the top end of the female bayonet connector (24). Said spring (23) is pressed into the hole, with the larger diameter coil going in first, until said coil reaches bottom. The internal threads are machined off center towards the lower end of the connector housing (22). Thread the lower end of the connector housing (22) onto the threads on the outside of the female bayonet connector (24) until connector housing (22) stops rotating, this forms the top end of the upper tube subassembly (34).

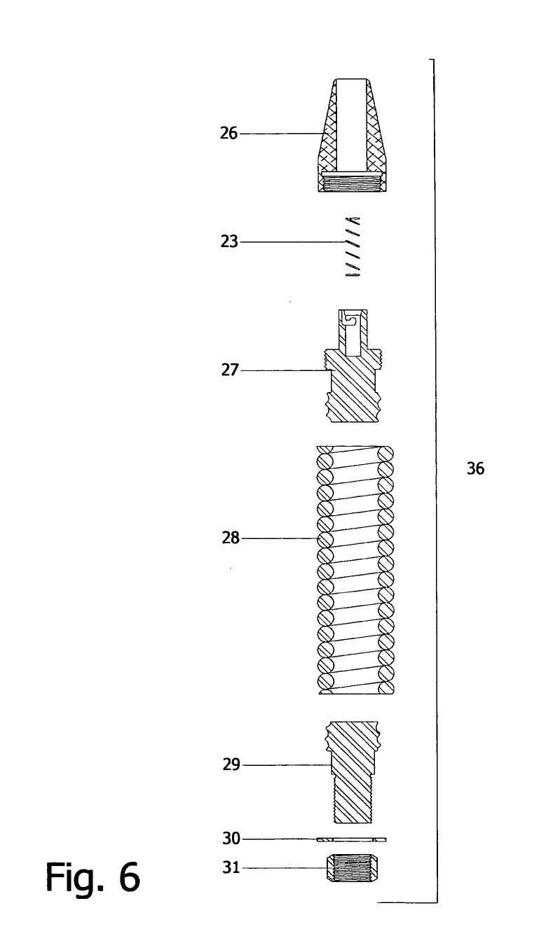

As illustrated in FIG. 6, insert the smaller threaded end of the spring stud mount (29) through the center of the washer (30) until the washer (30) rest against the shoulder just above the threads on the spring stud mount (29). Thread the nut (31) onto the spring stud mount (29) until the nut (31) stops against the previously placed washer (30). Thread the spring (28) onto the large threaded end of spring stud mount (29) until the spring (28) stops against the washer (30), these assembled parts (28, 29, 30, 31) are the lower end of the mounting subassembly (36). Thread the large end of the spring connector mount (27) into the top end of the spring (28) until the shoulder on spring connector mount (27) stops against the top edge of the spring (28). Compression spring (23) is formed with the bottom coil made slightly larger than the inside diameter of the machined hole in the top end of the spring connector mount (27). Said spring (23) is pressed into the hole, with the larger diameter coil going in first, until said coil reaches bottom. Place the internal thread end of connector housing (26) over the top end of spring connector mount (27) and thread down until the connector housing (26) stops turning.

1. I claim that this method and device for visual vehicle location will satisfy all the requirements set forth in this document has described in “Background of Invention” and “Abstract of Disclsure”.
